(19) United States
(12) Patent Application Publication
(10) Pub. No.: US 2010/0006592 A1
(43) Pub. Date: Jan. 14, 2010

(54) Method and apparatus for dosed dispensing of gasified liquid after pressure equalisation

(76) Inventors: Wilhelmus Johannes Joseph Maas, Someren (NL); Petrus Lambertus Wilhelmus Hurkmans, Someren (NL)

Correspondence Address: HARNESS, DICKEY & PIERCE, P.L.C., P.O. BOX 8910, RESTON, VA, 20195, US

(21) Appl. No.: 12/311,691

(22) PCT Filed: Oct. 10, 2007
(86) PCT No.: PCT/NL2007/000256

§ 371 Date: Jul. 10, 2009

(30) Foreign Application Priority Data
Oct. 10, 2006 (NL) 1032658

(51) Int. Cl. A23L 2/54; B67D 1/00; B01F 3/04

(52) U.S. Cl. 222/1; 99/323.1; 99/323.2; 222/145.5

(57) ABSTRACT

The invention relates to a method for dosed dispensing from a container of a liquid including a substance dissolved therein, like e.g. a carbonated beverage, wherein prior to dispensing of the liquid the pressure in the container is equalized with the ambient pressure in the space in which the liquid is dispensed, said pressure being equalized by first establishing a gas connection and only then establishing a liquid connection between the container and the space in which the liquid is dispensed. In accordance with the invention the liquid is dispensed from the container via a dosing chamber, prior to transferring of the liquid to the dosing chamber the pressure in the container is equalized with the pressure in the dosing chamber, and prior to dispensing of the liquid from the dosing chamber the pressure in said chamber is equalized with the ambient pressure in the space in which the liquid is dispensed. The invention further relates to a dispensing apparatus with which this method nay be performed and to an assembly of such a dispensing apparatus and a container.

The invention relates to a method for dosed dispensing from a container of a liquid including a substance dissolved therein and to an apparatus for performing said method. More in particular the invention relates to a method as defined in the preamble of claim 1 and to a dispensing apparatus as defined in the preamble of claim 6. Such a dispensing method and apparatus are known in the art, e.g. from U.S. Pat. No. 4,715,516.

The best known examples of liquid including a dissolved substance are carbonated beverages. Carbonated beverages include carbon dioxide which is dissolved in water or an aqueous solution. This process yields the “fizz” to carbonated water and sparkling mineral water, the head to beer, and the cork pop and bubbles to champagne and sparkling wine. “Fizz” is a word that is used to describe the action or sound of gas bubbles moving through and escaping from a liquid. Fizz also describes the formation of a foam of this gas and liquid at the top of the liquid's container. The official term to describe the escape of gas from an aqueous solution is effervescence. As a result of effervescence a carbonated beverage, such as cola or beer, will form bubbles when the dissolved carbon dioxide is depressurized to form emulsions at the top. This occurs when the container is opened and the beverage is poured into a glass.

Effervescence may cause problems when dispensing a carbonated liquid. In particular when the pressure differential between the inside of a beverage container and the space in which the carbonated liquid is dispensed is substantial, effervescence may lead to excessive foaming, which renders dispensing of an exactly determined dose, for instance a well filled glass, more difficult.

Another problem when dispensing a carbonated liquid is that direct communication between the interior of the container and the ambient air may lead to carbonic acid dissolving from the liquid and escaping from the container. The escape of carbonic acid will lead to a loss of sparkle that will moreover affect the taste of the remaining liquid. Since the trend in packaging calls for carbonated beverages being sold in ever larger bottles, from which a greater number of doses (glasses) may be dispensed before the bottle is emptied, the problem of gaseous carbonic acid escaping from the bottle has become a more serious issue over the years.

In an attempt to solve these problems the above-mentioned prior art document U.S. Pat. No. 4,715,516 discloses an apparatus for dispensing carbonated beverages from a container which has a body portion adapted to replace a screw top cap of the container. The body portion includes a tube which will project into the ullage volume of the container and will vent to the atmosphere via a normally closed vent valve. A normally closed fluid valve is disposed in the body portion between a fluid chamber and a spout. In use the container having the body portion attached thereto is essentially inverted and supported in a stand. A dispensing lever attached to the body is depressed and sequentially opens first the vent valve, permitting carbon dioxide gas collected in the ullage volume to be vented so as to prevent forceful ejection of the fluid, and then the fluid valve, permitting the beverage to flow from the container by gravity.

However, this known dispensing apparatus and the method by which it is used has the drawback that the carbon dioxide gas that has collected above the liquid in the container is still lost whenever a dose of liquid is dispensed. In this way the total amount of carbon dioxide in the container will decrease rapidly, leading to a loss of fizz and an alteration of the taste of the liquid.

The invention now has for its object to provide a method for dosed dispensing, in which these problems are obviated, at least to a certain extent. In accordance with the invention this is achieved by means of a method as defined in claim 1. By dispensing the liquid through a separate dosing chamber a two step dispensing method is obtained. In this way the pressure reduction is less sudden, thereby reducing the tendency for the liquid to foam. Moreover, in the first pressure equalization step no loss of carbon dioxide gas occurs, since the dosing chamber and the container form a closed system.

Preferred variants of the method in accordance with the invention are defined in the dependent claims 2 to 5.

The invention also aims to provide an apparatus with which the method as described above may be practised. In accordance with the invention this is accomplished by a dispensing apparatus as defined in claim 6.

Preferred embodiments of the dispensing apparatus in accordance with the invention are defined in the dependent claims 7 to 24.

Finally, the invention relates to an assembly of a dispensing apparatus and a container as defined in claims 25 to 28.

The invention is now illustrated by way of some examples, wherein reference is made to the annexed drawing, in which corresponding elements in the various embodiments are identified by reference numerals that are increased by 100, and in which:

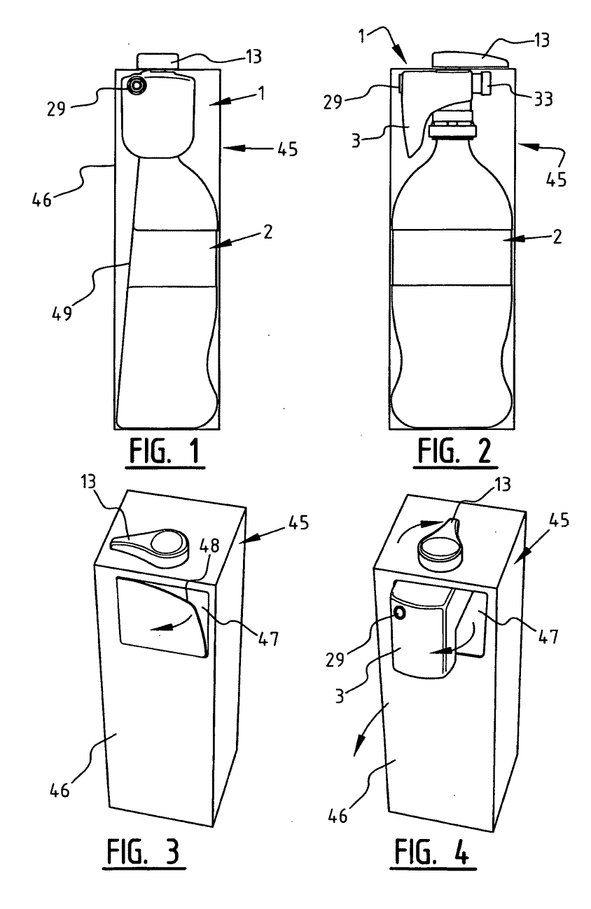

FIGS. 1 and 2 are a side view and a front view, respectively, of an assembly of a dispensing apparatus in accordance with a first embodiment of the invention, attached to a container and arranged in a packaging, in a transport and/or storage position,

FIGS. 3 and 4 are perspective views of the dispensing apparatus, container and packaging of FIGS. 1 and 2, showing how this is brought from its transport and/or storage position into its position of use,

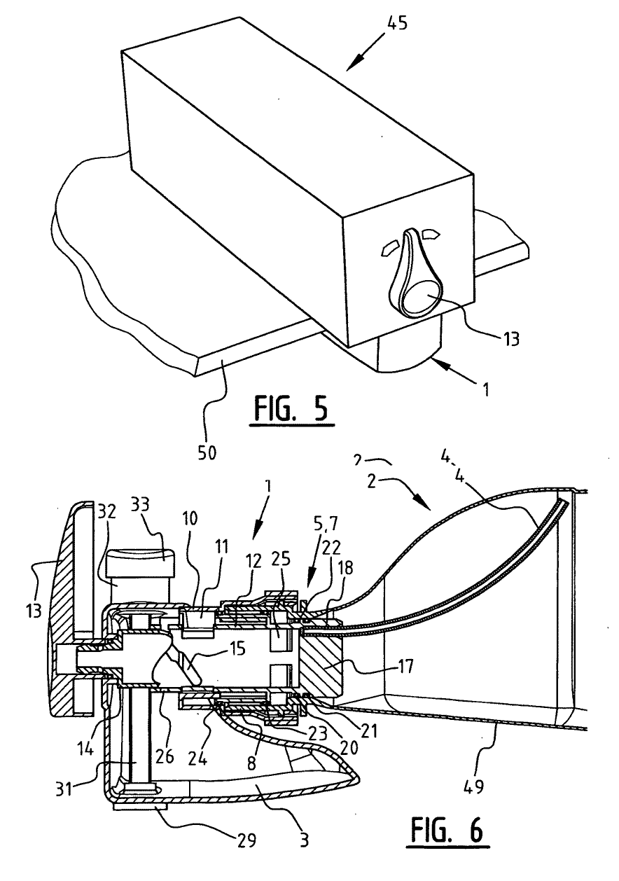

FIG. 5 is a perspective view of this embodiment of the dispensing apparatus, showing the assembly in its lying position of use,

FIG. 6 is a longitudinal section through the dispensing apparatus and part of the container of FIG. 1 to 5, in which the packaging has been omitted for reasons of clarity, prior to dispensing of a dose of liquid from the container,

FIG. 7 is a view corresponding with FIG. 6 of the dispensing apparatus during equalization of pressure between the container and the dosing chamber,

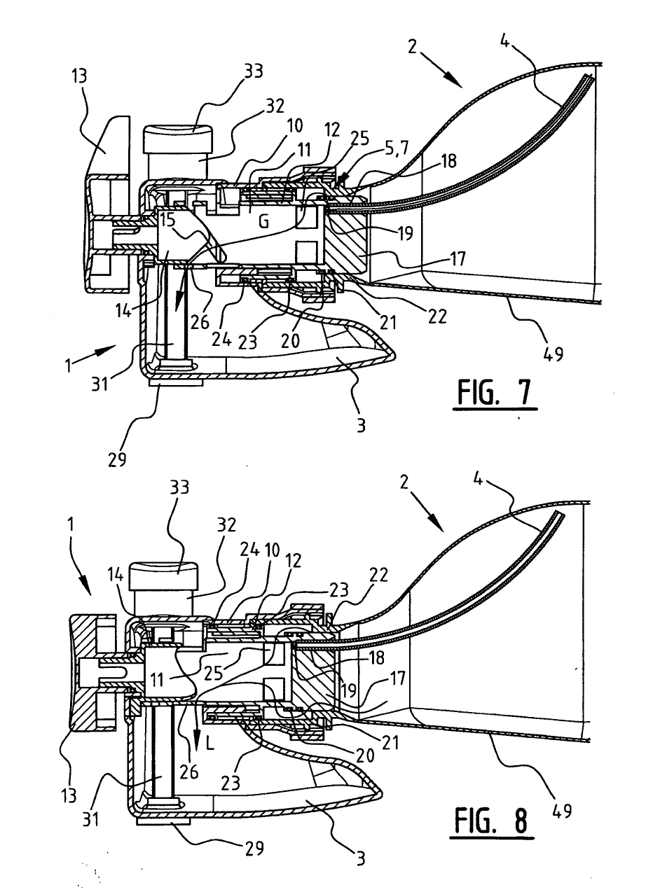

FIG. 8 is a view corresponding to FIGS. 6 and 7 of the dispensing apparatus during transfer of liquid from the container to the dosing chamber,

FIG. 9 is a partially cut-away side view of the first embodiment of the dispensing apparatus and part of the container, again without the packaging, when viewed from the other side, prior to dispensing of the dose of liquid from the dosing chamber,

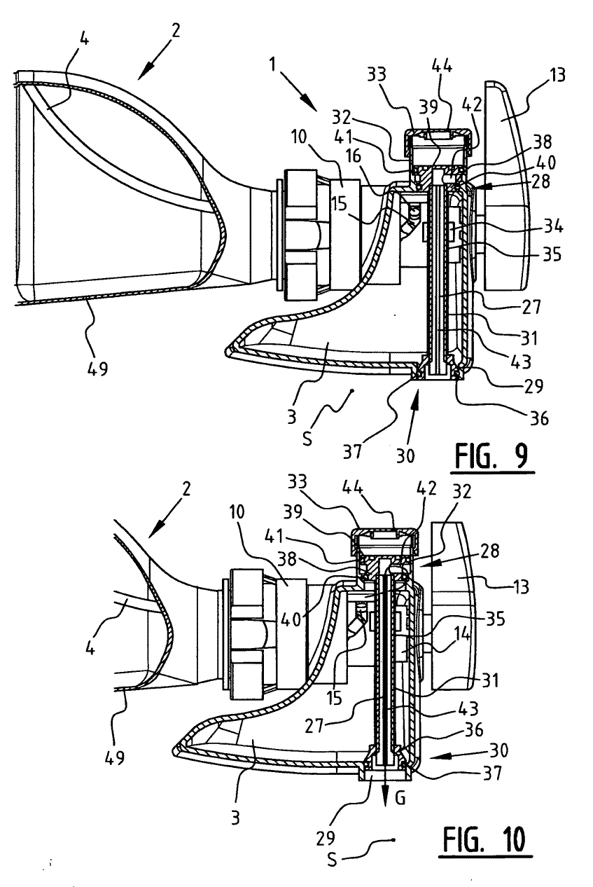

FIG. 10 is a view corresponding with FIG. 9 of the dispensing apparatus during equalization of the pressure between the dosing chamber and the surrounding area,

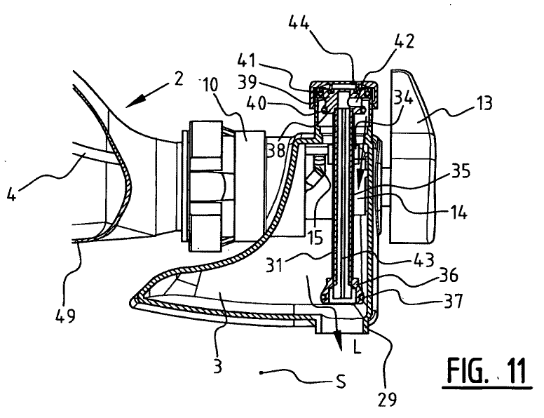

FIG. 11 is a view corresponding with FIGS. 9 and 10 of the dispensing apparatus during dispensing of the dose of liquid from the dosing chamber,

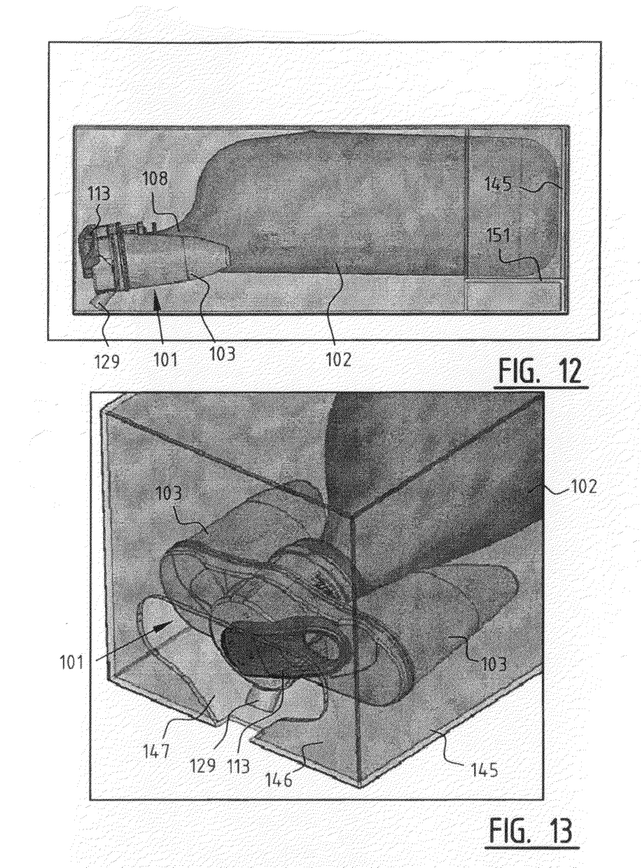

FIG. 12 is a side view of a second embodiment of the dispensing apparatus in accordance with the invention, attached to a container and arranged in a packaging, showing the assembly in a transport and/or storage position,

FIG. 13 is a perspective detail view of the dispensing apparatus of FIG. 12,

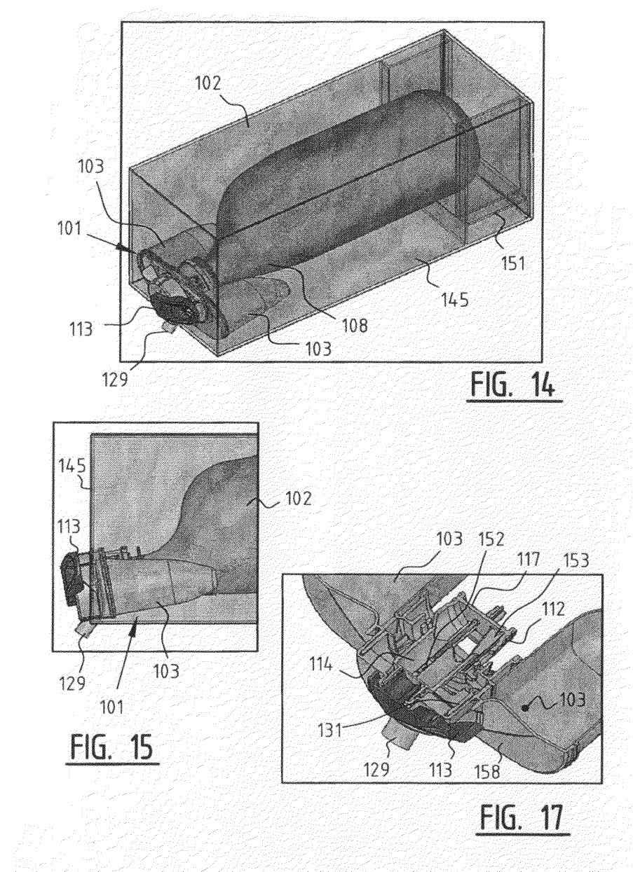

FIG. 14 is a perspective view of this embodiment of the dispensing apparatus in its lying position of use,

FIG. 15 is a side detail view showing the operating member and outflow conduit of the dispensing apparatus protruding from the packaging,

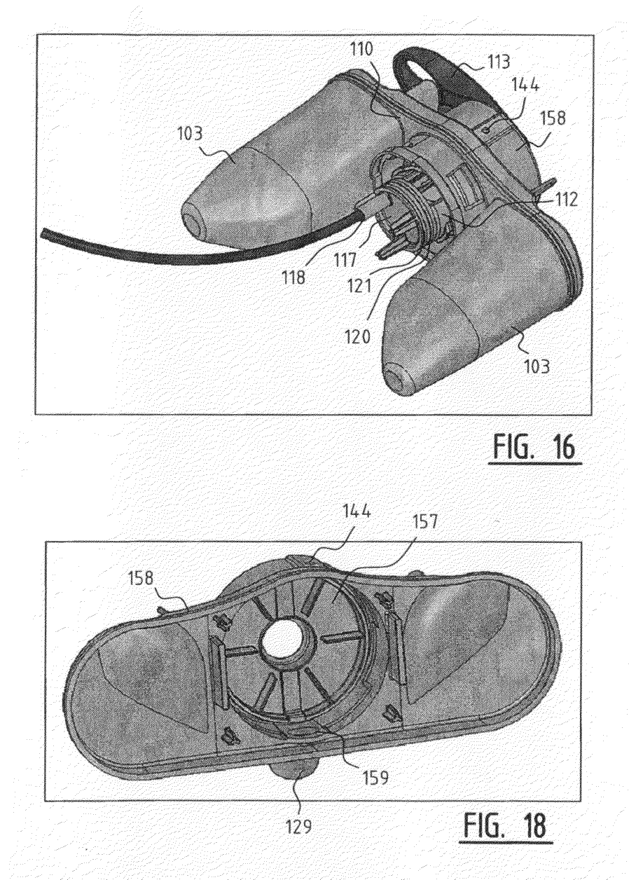

FIG. 16 is a perspective rear view of the dispensing apparatus,

FIG. 17 is a perspective horizontal sectional view of the dispensing apparatus of FIG. 16,

FIG. 18 is a rear perspective view of the front cover of the dosing chamber,

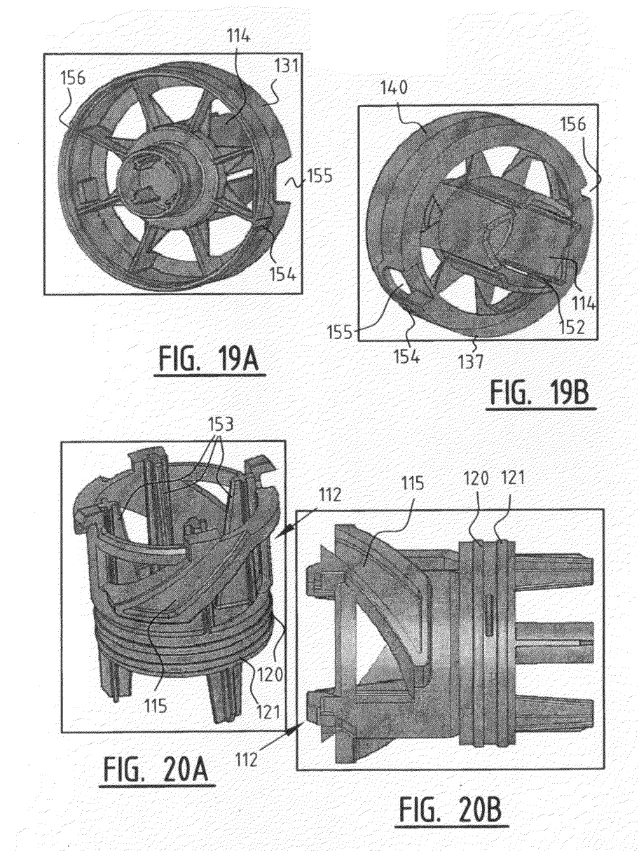

FIGS. 19A and 19B are front and rear perspective views, respectively, of an annular closure element used in this embodiment of the dispensing apparatus,

FIGS. 20A and 20B are a perspective view and a side view, respectively, of a tubular closure element used in this embodiment of the dispensing apparatus,

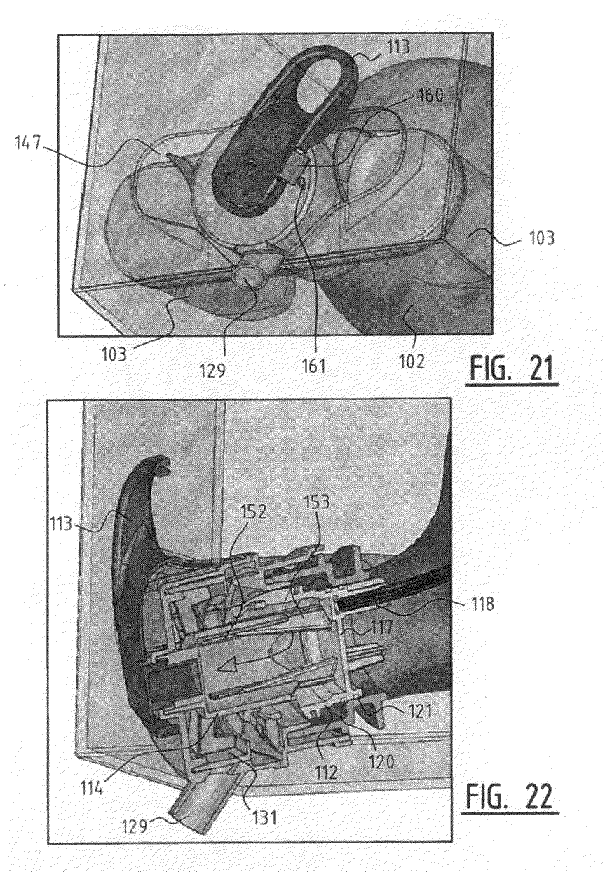

FIG. 21 is a perspective front view of the dispensing apparatus in the packaging, showing how the operating member is moved from its transport and storage position to its position of first use,

FIG. 22 is a perspective detail view in vertical section of the dispensing apparatus and part of the container during equalization of pressure between the container and the dosing chamber,

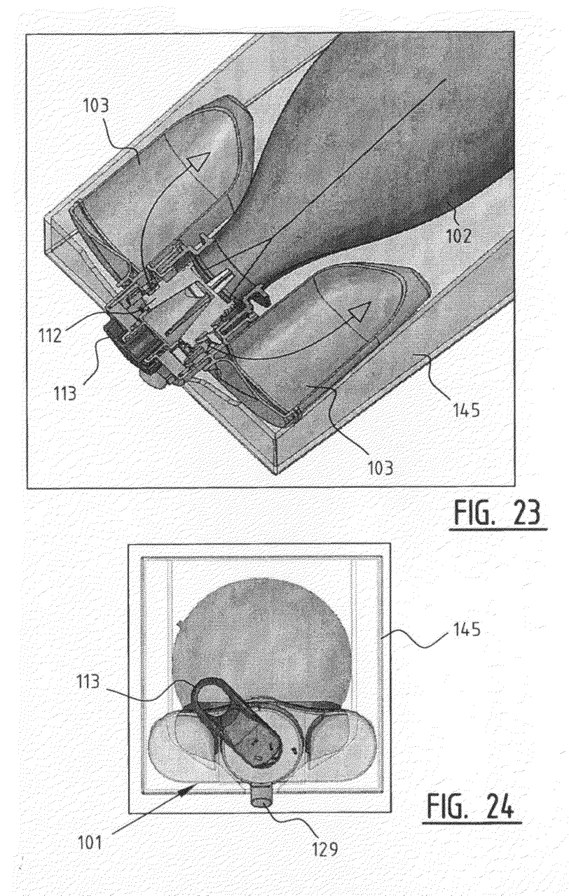

FIG. 23 is a perspective detail view in horizontal section of the dispensing apparatus during transfer of liquid from the container to the dosing chamber,

FIG. 24 is a front view of the apparatus in the packaging, showing the movement of the operating member during the steps shown in FIGS. 22 and 23,

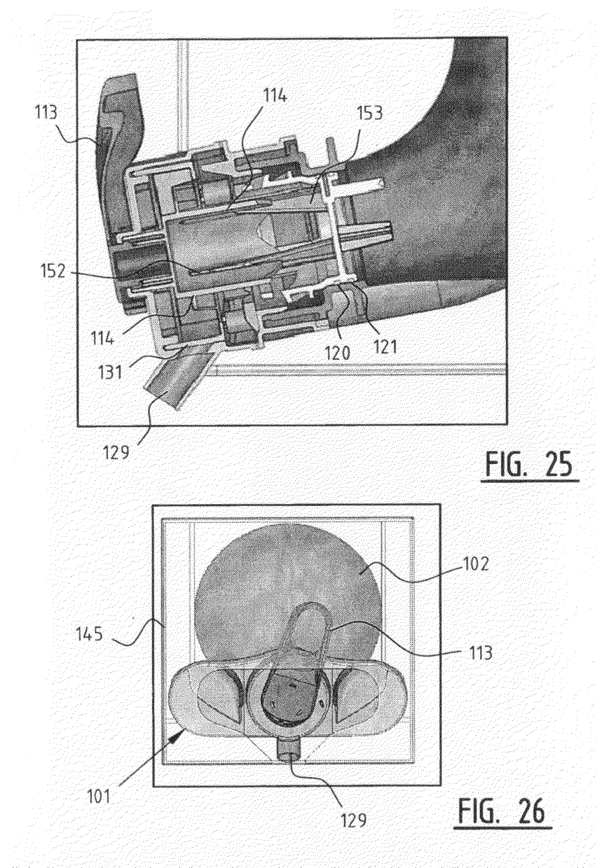

FIG. 25 is a detailed side view in vertical section of the dispensing apparatus prior to dispensing of the dose of liquid from the dosing chamber,

FIG. 26 is view corresponding to FIG. 24, showing the movement of the operating member to the position prior to dispensing,

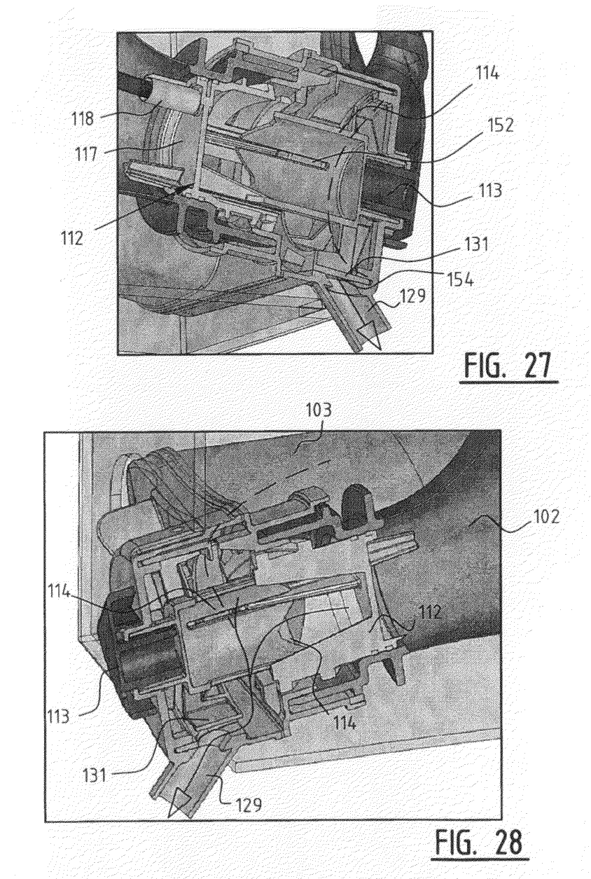

FIG. 27 is a perspective detail view in vertical section of the dispensing apparatus during equalization of pressure between the dosing chamber and the surrounding area, viewed from the other side,

FIG. 28 is a perspective detail view in vertical section of the dispensing apparatus during dispensing of the dose of liquid from the dosing chamber,

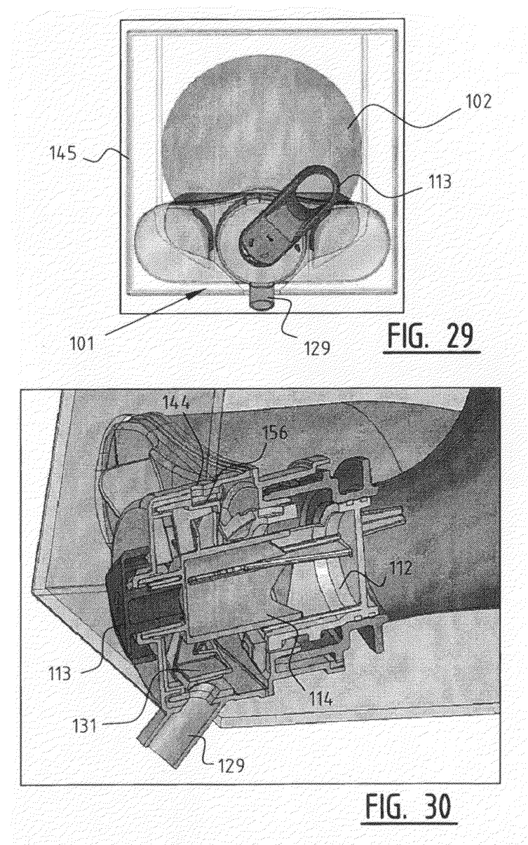

FIG. 29 is a view corresponding to FIGS. 24 and 26, showing the movement of the operating member during the steps shown in FIGS. 27 and 28,

FIG. 30 is a view corresponding to FIG. 28, showing the dispensing apparatus during venting at the end of the dispensing cycle,

FIG. 31 is a perspective detail view of the connection between the dosing chamber and the container in this embodiment of the dispensing apparatus,

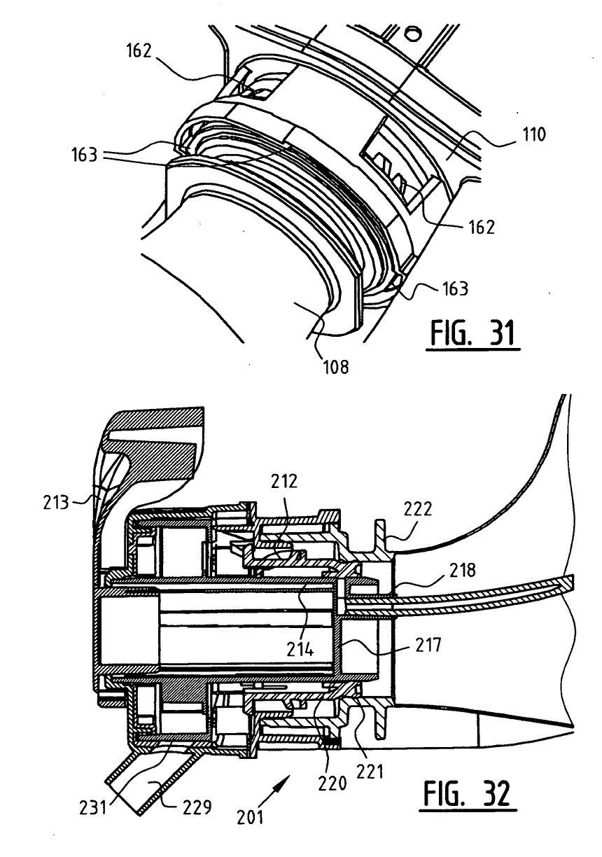

FIG. 32 is a detailed side view in vertical section of a third embodiment of the dispensing apparatus in accordance with the invention, in which the packaging has been omitted for reasons of clarity,

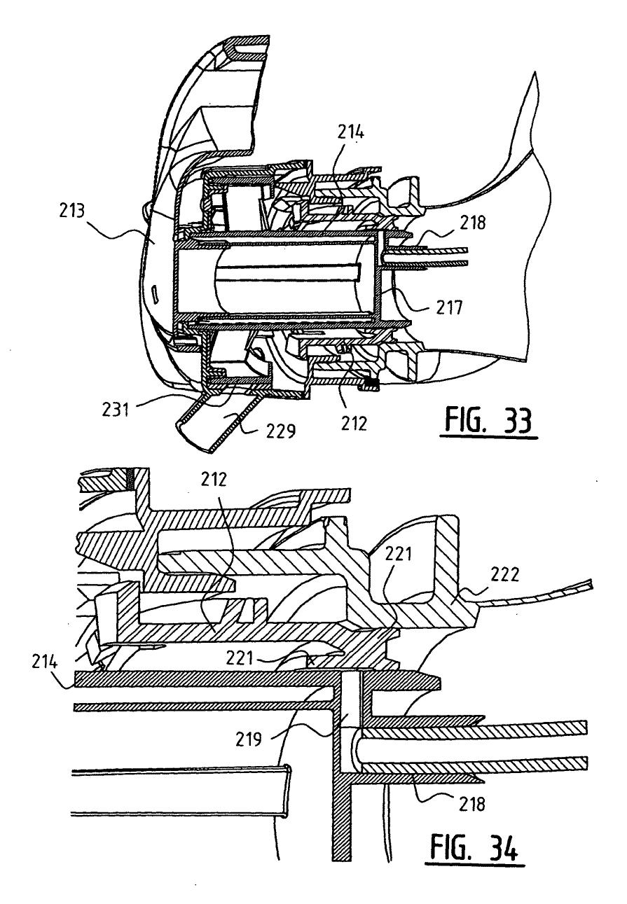

FIG. 33 is a perspective detail view in vertical section of the dispensing apparatus of FIG. 32 during equalization of pressure between the container and the dosing chamber,

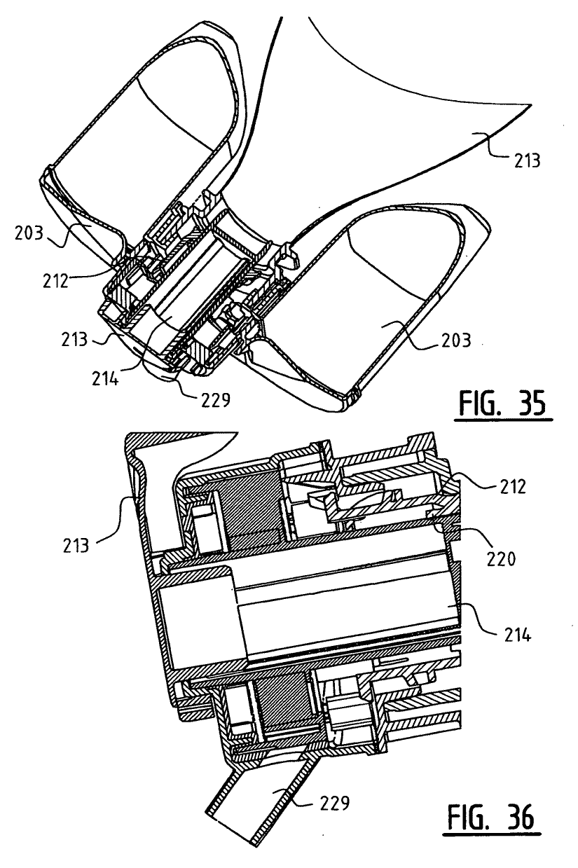

FIG. 34 is a further detailed view along the arrow XXXIV in FIG. 33,

FIG. 35 is a perspective detail view in horizontal section of the dispensing apparatus during transfer of liquid from the container to the dosing chamber,

FIG. 36 is a detailed side view in vertical section of this embodiment of the dispensing apparatus during equalization of pressure between the dosing chamber and the surrounding area, and

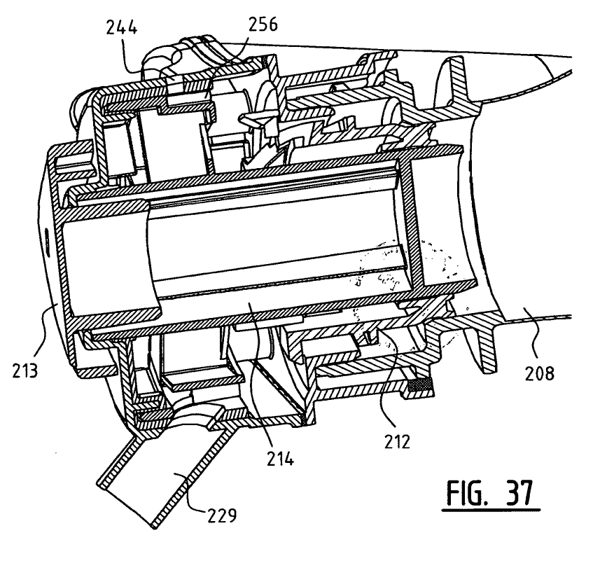

FIG. 37 is a perspective detail view in vertical section of the dispensing apparatus during dispensing of the dose of liquid from the dosing chamber and subsequent venting at the end of the dispensing cycle.

In accordance with the invention an apparatus 1 for dosed dispensing from a container 2 of a liquid L including a substance dissolved therein, for instance a carbonated drink, comprises a dosing chamber 3 connected to the container 2. The dispensing apparatus 1 is provided with means for equalizing the pressure in the container 2 with the ambient pressure in the space in which the liquid L is dispensed prior to dispensing of the liquid L. In accordance with the invention this pressure equalization takes place in two steps, namely first between the container 2 and the dosing chamber 3 and subsequently between the dosing chamber 3 and the surrounding area S in which the liquid L is dispensed in doses.

Equalization of pressure between the container 2 and the dosing chamber 3 and between the dosing chamber 3 and the surrounding area S always takes place by first establishing a gas connection between the spaces in which the pressure has to be equalized, before establishing a liquid connection therebetween.

To that end the pressure equalization means firstly comprise a primary gas line 4 connecting the container 2 and the dosing chamber 3, which is closeable by a first valve 5. The container 2 and the dosing chamber 3 are further connected by a liquid line 6, which is closeable by means of a second valve 7. In order to establish the gas connection before the liquid connection is formed, the first valve 5 is arranged to be opened before the second valve 7 is opened. To that end the first and second valves 5, 7 may be mutually connected or even integrally formed.

In the illustrated embodiment the container 2 has the shape of a bottle which is provided with a neck 8 in which an outflow opening 9 is defined. The dispensing apparatus 1 includes a connecting piece 10 which is snapped, clamped, or screwed onto the neck 8 of the container 2. This connecting piece 10 defines a conduit 11 leading to the dosing chamber 3. A tubular closure element 12 is axially slidable in the conduit 11. The closure element 12 is operated by a rotary operating member or turning knob 13, which is connected to a tubular stub 14 that is rotatably and slidably arranged in the free end of the closure element 12. To that end a groove 15 is formed in the closure element 12, in which a cam 16 arranged on the circumference of the tubular stub 14 is slidable.

The tubular closure element 12 has a relatively thick bottom part 17 having an axial blind bore 18 in which the end of the primary gas line 4, here in the shape of a thin plastic tube, is arranged. From this bore 18 a radial opening 19 is formed, which ends in the side wall of the closure element 12 between two annular gaskets 20, 21. These gaskets 20, 21 seal against a collar 22 in the neck of the container 2, in which the tubular element 12 itself is arranged with some play, and so act as first and second valves 5, 7. The closure element 12 further includes two annular gaskets 23, 24 which seal against a wider part of the neck 8 of the container 2 and a wall part of the connecting piece 10 of the dispensing apparatus 1, respectively. Finally, inflow openings 25 and outflow openings 26 are formed in the sidewall of the tubular closure element 12.

The pressure equalization means further comprise a secondary gas line 27 connecting the dosing chamber 3 with the surrounding area S, and which is closeable by a third valve 28. Finally, the dosing chamber 3 is connected with the surrounding area S by means of an outflow conduit 29, which is closeable by a fourth valve 30. In order to establish the gas connection before the liquid connection is formed, the third valve 28 is again arranged to be opened before the fourth valve 30 is opened. To that end the third and fourth valves 28, 30 may also be mutually connected or integrally formed.

The outflow conduit 29 is formed in the part of the dosing chamber 3 that is the lowermost point in the lying position of use of the container 2 and dispensing apparatus 1. In the dosing chamber 3 a hollow, rod-like closure element 31 is slidably arranged in the outflow conduit 29 on one hand and a neck 32 on the other. This neck 32 is closed off by a cap 33 having a venting opening 44 therein. This rod-like closure element 31 is also operated by the turning knob 13, which acts as a common operating member. To that end a part of the tubular stub 14 is formed as a pinion 34, while the closure element 31 is partly formed as a gear rack 35.

At its side which is directed downwards during use the rod-like closure element has a thickening 36, which fits with some play in the outflow conduit 29. This thickening 36 is provided with an annular gasket 37 that seals against the wall of the outflow conduit 29 and in that manner functions as the fourth valve 30. On the opposite side the rod-like closure element 31 is provided with two disc-shaped parts 38, 39 having different diameters, which are arranged with some play in the neck 32, of which the inner wall is twice stepped. Each disc 38, 39 is again provided with an annular gasket 40, 41, which seals against the corresponding part of the inner wall of the neck 32. The annular gasket 40 on the lower disc 38 forms the third valve 28, while the gasket 41 on the upper disc 39 forms a fifth valve which closes off a vent line running from the venting opening 44 to the interior of the dosing chamber 3. A radial bore 42 is formed in the closure element 31 between the two discs 38, 39. This radial bore 42 leads to an axial bore 43, which in turn leads to the outflow opening 29. The bores 42 and 43 form part of the secondary gas line 27.

Finally, in the illustrated embodiment the container 2 and the dispensing apparatus 1 are arranged in a rectangular cardboard packaging 45, from which the turning knob 13 protrudes at the top. In a sidewall 46 of the packaging 45 an opening 47 is formed which is closed by a flap 48 that may be torn loose. The packaging 45 has for its effect that the container 2 and the dispensing apparatus 1, which have complex shapes and are moreover movable with respect to one another, may be stored and transported in a simple and reliable manner, without the dispensing apparatus 1 inadvertently being operated, which would lead to leakage of liquid from the container 2.

The operation of the apparatus 1 during dosed dispensing from the container 2 of the liquid including the substance dissolved therein, for instance a carbonated soft drink or beer, is as follows.

First the flap 48 is torn loose, so that the opening 47 in the sidewall 46 of the packaging 45 is exposed (FIG. 3). Then by turning the turning knob 13 the dispensing apparatus 1 is rotated over a quarter turn with respect to the container 2, so that it is brought from its transport and/or storage position, in which it lies on the side of the neck 8 closest to the container centerline (FIG. 1, 2) into its position of use, in which it lies on the side of the neck 8 facing away from the centerline (FIG. 4). Use is made herein of a once-only threaded or bayonet mechanism between the dispensing apparatus 1 and the container 2. In this position of use the dispensing apparatus 1 protrudes past a flat side 49 of the container 2 (FIG. 6). Then the packaging 45 is laid down flat on a shelf 50 in a refrigerator (FIG. 5), after which the dispensing apparatus is ready for use (FIG. 6).

In this position, in which the turning knob 13 occupies a neutral position pointing upwards, the tubular closure element 12 is in its extreme position in the neck 8 of the container 2. In that position the closure element 12 with its annular gaskets 20, 21—the first and second valves 5, 7—sealingly closes off both the primary gas line 4 and the liquid line 4, so that the dosing chamber 3 is completely isolated from the container 2. Moreover, in this neutral position of the turning knob 13 the rod-like closure member 31 is in its lowermost position, so that the annular gaskets 38, 37—the third and fourth valves 28, 30—close off the secondary gas line 27 and the outflow conduit 29 (FIG. 9). Also in this position of the closure member 31 the venting opening 44 is closed off from the dosing chamber 3 by means of the annular gasket 41 on the top disc 39—the fifth valve—so that the chamber is completely isolated from the surrounding area S.

By now turning the turning knob 13 counter-clockwise—in the view of FIG. 6 to 8 into the plane of the drawing—the tubular closure element 12 is pulled out of the neck 8, in FIG. 6 to 8 to the left, by cooperation between the cam 16 on the tubular stub 14 and the groove 15. In first instance this leads to release of the primary gas line 4, since the gasket 20 is moved past the end of the collar 22, whereby the radial bore 19 leads to the conduit 11 around the closure element 12. In this way a gas connection is established and gas G can flow from the container 2 to the dosing chamber 3 to equalize the pressure (FIG. 7). Because the primary gas line 4 is too narrow to allow liquid through, and further ends in the container 2 above the level of the liquid, no liquid can flow from the container 2 through that line. The liquid line continues to be closed off by the gasket 21.

When the knob 13 is turned further in the same direction, the tubular closure element 12 is pulled even further from the neck 8, so that also the gasket 21 passes the end of the collar 22, and the liquid L may flow into the conduit 11 around the bottom 17 of the closure element 12 (FIG. 8). From the widened part of the conduit the liquid L flows through the inflow openings 25 into the closure element 12, and then flows through the outflow openings 26 to the dosing chamber 3. In this way the liquid connection between the container 2 and the dosing chamber 3 is established.

Because the pressure has already been equalized, the liquid L will smoothly flow from the container 2 to the dosing chamber 3, and the substance dissolved therein will not be suddenly released. Therefore no excessive foaming will occur in the dosing chamber 3. Moreover, the gas G that flowed from the container 2 into the dosing chamber 3 during pressure equalization will be forced out of the dosing chamber by the arrival of the liquid L. This gas G will flow back into the container 2, thus minimizing the loss of gas during dispensing.

The moment of opening of the first and second valves 5, 7 during the turning movement of the turning knob 13 is determined by the shape of the groove 15. In the illustrated embodiment this has a kink, so that the ratio between the turning movement of the knob 13 and the sliding movement of the closure element 12 is varied.

During the counter-clockwise movement of the turning knob 13 the rod-like closing member 31 will not move, because the gear rack segment 35 does not mesh with the pinion 34 on the tubular stub 14 in that position. Thus the dosing chamber 3 remains isolated from the surrounding area S.

When the dosing chamber 3 has been filled, the knob 13 is moved clockwise until it points upwards again, indicating that it has reached its neutral position (FIG. 9). In this way the tubular closure member 12 is again pressed into the neck 8 of the container 2, so that the first and second valves 5 and 7 are closed again and the dosing chamber 3 is isolated from the container 2 again. It should be noted that filling of the dosing chamber 3 is visible from the outside, since this chamber 3 is at least partly made from a transparent or translucent material.

Now the dose of liquid L may be dispensed from the dosing chamber 3, for instance into a glass (not shown here) that is held under the outflow opening 29. To that end the knob 13 is turned in clockwise direction—in the views of FIG. 9 to 11 into the plane of the drawing—whereby the pinion 34 on the tubular stub 14 meshes with the gear rack 35 on the rod-like closure member 31, which is moved upwards as a result.

During that movement initially the annular gasket 40 on the bottom disc 38, which forms the third valve 28, is moved away from the bottom step of the inner wall of the neck 32 (FIG. 10). In this way a gas connection is established between the dosing chamber 3 and the surrounding area S via the secondary gas line 27, which is formed i.a. by the bores 42, 43. Through this line gas G can flow from the dosing chamber 3 to the surrounding area S in order to equalize the pressure. Because the secondary gas line 27 is too narrow to let liquid pass, and further ends in the dosing chamber 3 above the liquid level, no liquid can flow from the dosing chamber 3 through that line. The liquid line 29 continues to remain closed off by the gasket 37 or fourth valve 30. It should be noted that even if some very small drops of liquid would be carried along through the secondary gas line 27, this would not lead to any leakage, since this gas line ends in the outflow conduit 29, under which the glass is held.

When the knob 13 is now turned further in the same direction, the rod-like closure member 31 is moved further upwards, so that the gasket 37 is released from the outflow conduit 29 and the liquid L may flow from the dosing chamber 3 (FIG. 11). In this way the liquid connection is established between the dosing chamber 3 and the surrounding area S. Because the pressure has already been equalized, the liquid L will smoothly flow from the dosing chamber 3 into the glass, and the substance dissolved therein will not be suddenly released. Therefore, no excessive foaming will occur in the glass. During this movement of the closure member 31 the gasket 41 on the top disc 39 further passes the intermediate step of the inner wall of the neck 32, so that a connection is formed between the vent opening 44 in the cap 33 and the dosing chamber 3. In this way ambient air from the surrounding area S may flow in to replace the liquid L flowing out, so that an even efflux without “gurgling” is achieved. This is particularly important for carbonated liquids. By partly covering the vent opening 44 with a finger, the user may furthermore control the outflow rate.

It should be noted that during dispensing of the liquid L from the dosing chamber 3 the first and second valves 5, 7 remain closed, thus isolating the container 2 from the dosing chamber 3 and from the surrounding area S. This is due to the fact that the groove 15 has a segment which extends tangentially of the tubular closure element 12, so that rotation of the tubular stub 14 does not impart any axial sliding movement on the tubular closure element 12.

After the entire dose of liquid L from the dosing chamber 3 has been poured into a glass, the knob 13 is turned back counter-clockwise to its neutral position, in which it points upwards (FIG. 6). After that the dispensing apparatus 1 is again ready for dispensing a next dose of liquid L.

In a second embodiment of the invention the dispensing apparatus 101 is fixed to the neck 108 of the container 102, rather than being pivotable from a transport and storage position to a position of use. The fixation in axial direction is achieved by snap couplings 162, while the fixation in radial direction is accomplished by a one way snap type bayonet 163 (FIG. 31). In this embodiment the dispensing apparatus includes two dosing chambers 103 arranged on opposite sides of the container neck 108 and connected by a connecting piece 110. The container 102 and the dispensing apparatus 101 are again arranged in a rectangular cardboard packaging 145 having an opening 147 in an end wall 146. The packaging 145 includes a stepped part 151, which ensures that the dispensing apparatus 101 is lower than the container 102 when the container 102 has been moved from its transport and/or storage position (FIG. 12, 13) to its position of use (FIG. 14, 15) in which the dispensing apparatus 101 is accessible through the opening 147.

In this second embodiment the first and second valves 105, 107 are again formed by annular gaskets 120, 121 that are arranged on the circumference of a tubular closure element 112 and that seal against a collar 122 in the container neck 108. Here again, the primary gas line 104 is a thin tube that ends in a bore 118 in the bottom 117 of the closure element 112. From this bore 118 a radial opening 119 runs to the side wall of the closure element 12 between the two annular gaskets 120, 121.

The tubular closure element 112 of this embodiment is not just slidable, but also rotatable. It includes two helical grooves 115 arranged on opposite sides, which cooperate with cams 116 that are formed on the inner wall of the connecting piece 110. The movement of the tubular closure element 112 is provided by a rotary operating member or turning knob 113, which is connected to the tubular closure element 112 by a tubular stub 114, onto which the turning knob 113 is fixed by a snap connection. This tubular stub 114 is integrally formed with an annular closure element 131. This annular closure element 131 carries the third and fourth valves 128, 130. Slits 152 in the tubular stub 114 mate with ribs 153 on the tubular closure element 112 to transmit rotary movement from the turning knob 113 while allowing the closure element 112 to slide axially with respect to the tubular stub 114.

The annular closure element 131 is accommodated in a cup-shaped protrusion 157 on a front cover 158 of the dispensing apparatus 101. The closure element 131 has three recesses 154, 155 and 156 arranged in its outer surface. The first recess 154 forms part of the secondary gas line 127 when it is aligned with the outflow conduit 129 that is arranged at the bottom of the cover 158. The second recess 155 allows liquid to pass from the dosing chambers 103 to the outflow conduit 129 when it is aligned with the outflow conduit 129. Finally, the third recess 156 forms part of the vent line when it is aligned with the venting opening 144 that is arranged in the top of the cover 158. The third and fourth valves 128, 130 are formed by sealing surfaces 140 and 137 between the various recesses 154, 155 and 156. These sealing surfaces 137, 140 cooperate with sealing layers 159 on the inner wall of the protrusion 157 around the mouth of the outflow conduit 129 and around the venting opening 144, respectively. The sealing layers 159 are made from a somewhat softer and more resilient material than the cover 158.

The operation of this embodiment of the dispensing apparatus 101 is as follows. After the dispensing apparatus 101 has been moved to its position of use (FIG. 14, 15) the turning knob 113 is rotated towards its upright neutral position (FIG. 21). In this neutral position all valves are closed. During this movement an anti tamper part 160 of the turning knob 113 is broken off by a protrusion 161 on the front cover 158.

Then the knob 113 is turned clockwise over a small angle, which results is a slight axial movement of the tubular closure element 112, so that the gasket 120 passes the collar 122 and the primary gas line 104 forms a connection between the container 102 and the dosing chambers 103. This allows the gas G to flow into the dosing chambers 103, thus equalizing the pressure with the container 102 (FIG. 22). This position may be indicated by a small protrusion (not shown) on the front cover 158 contacting the turning knob 113 so as to provide a slight increase in resistance.

Continued clockwise movement of the turning knob 113 pulls the tubular element 112 further from the container neck 108 towards the dosing chambers 103, so that the second gasket 121 passes the collar and a liquid connection is established between the container 102 and the dosing chambers 103 (FIG. 23, 24). The position of the recesses 154-156 on the annular closure element 131 is such, that the sealing surfaces 137, 140 remain in contact with the sealing layers 159 around the outflow opening 129 and the venting opening 144, so that the dosing chambers 103 remain isolated from the surrounding area S.

After the dosing chambers 103 have been filled, the knob 113 is moved counter-clockwise to its neutral position (FIG. 25, 26) and then further to a position in which the first recess 154 in the annular closure element 131 becomes aligned with the outflow conduit 129 (FIG. 27). This establishes a gas connection between the dosing chambers 103 and the surrounding area, allowing the pressure to be equalized. The recess 154 is so small that virtually no liquid will escape during pressure equalization. However, even if it would, it would flow through the outflow conduit 129 into a glass held by a user of the apparatus, so that there will be no leakage.

The knob 113 is then turned further counter-clockwise to align the larger second recess 155 with the outflow conduit 129 (FIG. 28), thus establishing a liquid connection and allowing the liquid L to be dispensed from the dosing chambers 103. When the turning knob 113 reaches the end of its movement the third recess 156 in the annular closure member 131 will be aligned with the venting opening 144 and the dosing chambers 103 may be vented to prevent a vacuum from being formed when the liquid L is dispensed (FIG. 29, 30). When the dosing chambers 103 have been emptied, the knob 113 may be turned back in clockwise direction to its neutral position, thus closing all the valves.

In a third embodiment of the dispensing apparatus 201 (FIG. 32) the tubular closure element 212 does not have any separate gaskets at all. Sealing is achieved by the periphery of the tubular element 212 itself, which has a radially protruding ridge 221 that engages the collar 222 and forms the second valve 207. This is made possible by selecting a somewhat more resilient material for the tubular closure element 212 than in the previous embodiments.

In order to prevent the tubular element 212 from deforming, which might lead to leaking, the tubular stub 214 extends over the entire length of the tubular closure element 212. This stub 214 is made from a stiffer material. In this embodiment the bottom 217 closing off the container neck 208 forms part of the tubular stub 214, rather than of the tubular closure element 212. Consequently, the bores 218, 219, which form part of the primary gas line 204 are also formed in the tubular stub 214. The first valve 205 which selectively closes off the primary gas line 204 is formed by an annular flange 220 on the inside of the tubular closure element 212. This flange 220 includes a slight recess that may be aligned with the bore 219 upon initial turning movement of the closure element 212 (FIG. 33, 34).

In operation, this third embodiment of the dispensing apparatus 201 corresponds substantially with the second embodiment of the apparatus 101, which was described in detail above. The successive steps of establishing a gas connection between the container 202 and the dosing chambers 203 for pressure equalization by opening the first valve 205, establishing a liquid connection between the container 202 and the dosing chambers 203 by opening the second valve 207, isolating the dosing chambers from the container 202 and from the surrounding space S, establishing a gas connection between the dosing chambers 203 and the surrounding area S for pressure equalization by opening the third valve 240, establishing a liquid connection between the dosing chambers 203 and the surrounding area S for dispensing the liquid L by opening the fourth valve 237 and finally venting the dosing chambers 203 by opening the fifth valve are illustrated in FIGS. 33, 34, 35, 36 and 37, respectively.

In this way the invention provides a method and an apparatus with which liquids that include a dissolved substance, like carbonated beverages, may be dispensed in a controlled and exactly dosed manner, without the dissolved substance suddenly being released and leading to excessive foaming.

Although the invention has been described above by way of an example, it will be clear that it is not limited thereto. For instance, the pressure equalizing means might be embodied differently than described and illustrated here, for example in the form of closeable openings, conduits that are integrated in the container and/or the dosing chamber, or in other ways. It is further conceivable that the valves for the gas line(s) and the liquid line(s) could be operated differently, for instance by means of separate operating members. Moreover, when a dosing chamber is used, it is not always necessary to apply pressure equalization in both steps. Furthermore, it is not always necessary to apply pressure equalization before dispensing of each dose. Often the pressure differential will especially be large as long as the container is almost full, so that the need for pressure equalization becomes less when the container is further emptied. Finally, it should be stressed that while the invention has been described primarily in connection with carbonated beverages, it also applies to other liquids having substances dissolved therein. For instance, in some beverages nitrogen rather than carbon dioxide is used to produce “fizz”. Obviously, other liquids than beverages are also potential candidates for dispensing using the method and apparatus of the invention.

Consequently, the scope of the invention is solely determined by the following claims.

1. A method for dosed dispensing from a container of a liquid including a substance dissolved therein, wherein prior to dispensing of the liquid the pressure in the container is equalized with the ambient pressure in the space in which the liquid is dispensed, said pressure being equalized by first establishing a gas connection and only—then establishing a liquid connection between the container and the space in which the liquid is dispensed,
wherein:—the liquid is dispensed from the container via a dosing chamber,
prior to transferring of the liquid to the dosing chamber the pressure in the container is equalized with the pressure in the dosing chamber, and
prior to dispensing of the liquid from the dosing chamber the pressure in said chamber is equalized with the ambient pressure in the space in which the liquid is dispensed.

2. The method as claimed in claim 1, wherein the pressure in the container and the dosing chamber is equalized by first establishing a gas connection and only then establishing a liquid connection between the container and the dosing chamber, wherein the gas and liquid connections between the container and the dosing chamber are severed before the pressure in the dosing chamber is equalized with the pressure in the space.

3. The method as claimed in claim 1, wherein the dosing chamber is vented during or after dispensing of the liquid therefrom.

4. The method as claimed in claim 3, wherein the dosing chamber is vented by establishing an additional gas connection between the dosing chamber and the space.

5. The method as claimed in claim 1, wherein the container contains a plurality of doses and at least prior to dispensing of the first dose the pressure in the container is equalized with the ambient pressure in the space in which the liquid is dispensed.

6. An apparatus for dosed dispensing from a container of a liquid including a substance dissolved therein, said apparatus comprising means for equalizing the pressure in the container with the ambient pressure in the space in which the liquid is dispensed prior to dispensing of the liquid, said pressure equalizing means comprising at least one closeable gas line connecting the container and the space, characterized by a dosing chamber connected to the container, wherein the pressure equalizing means comprise at least one primary gas line connecting the container and the dosing chamber and closeable by a first valve and at least one secondary gas line connecting the dosing chamber and the space and closeable by a third valve.

7. The dispensing apparatus as claimed in claim 6, wherein the container and the dosing chamber are connected by a liquid conduit that is closeable by a second valve, wherein the first valve is arranged to be opened before the second valve is opened.

8. The dispensing apparatus as claimed in claim 7, wherein the first and second valves are mutually connected.

9. The dispensing apparatus as claimed in claim 7, wherein the first and second valves are integrally formed.

10. The dispensing apparatus as claimed in claim 8, wherein the container has a neck defining an outlet opening and in that the first and second valves comprise spaced apart annular gaskets arranged on a tubular closure element that is slidably arranged in the container neck.

11. The dispensing apparatus as claimed in claim 10, wherein the tubular closure element is operably connected to a rotary operating member through a cam and groove mechanism.

12. The dispensing apparatus as claimed in claim 6, wherein the dosing chamber is connected to the space by an outflow conduit that is closeable by a fourth valve, wherein the third valve is arranged to be opened before the fourth valve is opened.

13. The dispensing apparatus as claimed in claim 12, wherein the third and fourth valves are mutually connected.

14. The dispensing apparatus as claimed in claim 12, wherein the third and fourth valves are integrally formed.

15. The dispensing apparatus as claimed in claim 13, wherein the third and fourth valves comprise spaced apart annular gaskets arranged on a rod-like closure element that is slidably arranged in the outflow conduit.

16. The dispensing apparatus as claimed in claim 15, wherein the rod-like closure element is operably connected to a rotary operating member through a rack and pinion mechanism.

17. The dispensing apparatus as claimed in claim 13, wherein the third and fourth valves comprise sealing surfaces arranged on the circumference of an annular closure element that is rotatably arranged adjacent the outflow conduit.

18. The dispensing apparatus as claimed in claim 11, wherein the annular closure element interconnects the rotary operating member and the tubular closure element.

19. The dispensing apparatus as claimed in claim 12, wherein the first and second valves are arranged to be closed when the third and/or fourth valves are opened and in that the third and/or fourth valves are arranged to be closed when the first and second valves are opened.

20. The dispensing apparatus as claimed in claim 19, wherein the first, second, third and fourth valve are all operably connected to a common operating member that has a neutral position in which all valves are closed, said operating member being movable from said neutral position in a first direction to successively open the first valve and the second valve, while the third and fourth valves remain closed, and further being movable in a second direction to successively open the third valve and the fourth valve, while the first and second valves remain closed.

21. The dispensing apparatus as claimed in claim 11, wherein the groove has a first segment extending at least partially in axial direction of the tubular closure member and a second segment extending substantially tangentially of the tubular closure member.

22. The dispensing apparatus as claimed in claim 6, wherein a vent line connecting the dosing chamber with the space and closeable by a fifth valve, wherein the fifth valve is arranged to be opened after the fourth valve is opened.

23. The dispensing apparatus as claimed in claim 13, wherein the fifth valve is connected or integrally formed with the third and fourth valves.

24. The dispensing apparatus as claimed in claim 20, wherein the fifth valve is operatively connected to the common operating member.

25. An assembly of a dispensing apparatus as claimed in claim 6 and a container, wherein the container has a neck defining an outlet opening, the neck being offset with respect to a centerline of the container.

26. The assembly as claimed in claim 25, wherein the dispensing apparatus is pivotably connected to the container neck so as to be movable from a transport and/or storage position, in which it lies on the side of the neck closest to the container centerline to a position of use in which it lies on the side of the neck facing away from the centerline.

27. The assembly as claimed in claim 25, wherein the dispensing apparatus has two dosing chambers arranged on opposite sides of the neck.

28. The assembly as claimed in claim 25, wherein the container and dispensing apparatus are arranged in a substantially rectangular packaging, said packaging including an access opening closed by a removable cover.
